(19) United States
(12) Patent Application Publication
(10) Pub. No.: US 2006/0167990 A1
(43) Pub. Date: Jul. 27, 2006

(54) System for presenting and controlling information on a display device

(76) Inventors: Max Kim Tobiasen, Copenhagen (DK); Nikolaj Friis Mobius, Copenhagen (DK)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/532,062

(22) PCT Filed: Oct. 24, 2003
(86) PCT No.: PCT/IB03/04706

§ 371 Date: Apr. 21, 2005

(30) Foreign Application Priority Data
Oct. 24, 2002 (DK) PA 2002 01620

(51) Int. Cl. G06F 15/16

(52) U.S. Cl. 709/204

(57) ABSTRACT

The present invention relates to a system (34) and a display (10), particularly a display (10) that is updated via a means of transferring data from a central server (32) to the display (10) using a wireless technology (30, 18) and that comprises a rotary member (12, 13) with light emitting diodes rotating about an axis thereby providing an image.

### FIELD OF INVENTION

This invention relates to a system and a display, particularly a display that is updated via a means of transferring data from a central server to the display using a wireless technology.

### BACKGROUND OF INVENTION

Displaying systems comprising a rotary member having a plurality of light emitting diodes and a means of controlling these to create the appearance of an image are known technologies. Displays utilising this technology are, however, only available in one colour, as the light emitting diodes can only be switched on and off, creating one colour. This creates a serious limitation on the usability of the display device, as it is not possible to create multicoloured images.

Furthermore, display devices communicating with a central server using a land based Internet connection, or a land based direct connection are known technologies. This is generally accomplished by setting up an Internet connection through a phone line, or a DSL line, assigning an IP address to the display device, or a peripheral unit able to communicate with the display device. A central server connected to the Internet is able to communicate with the display device using Internet protocol. It is also known technology to update or interact with a display device through the Internet, comprising the steps of communicating from a browser or a program to the central server, communicating from the server to the display device, and updating the display device. This technology comprises, however, a limitation, as the display needs to have a land based connection and cabling, making it hard to move the display device to another location, and complicating the setup process of a display device, as a land based connection is, needed for each display device.

### SUMMARY OF THE INVENTION

An object of the present invention is to solve the above identified problems in the known technologies. In particular, it is the object of the present invention to provide a system and a colour display unit enabling a user to interact with the display device by communicating with a central server through a wireless gateway using a wireless mobile device such as a mobile or cellular phone, a personal digital assistant, or a computer device.

A particular advantage of, the present invention is provision of a system and display device for providing advertisement which may be changed in accordance with any particular offer e.g. a short term offer in a shop or restaurant.

A particular feature of the present invention relates to the provision of a touch sensitive area on the display device enabling a user to interact with the display device.

The above objects, advantage and feature together with numerous other objects, advantages and features, which will become evident from below detailed description, is obtained according to a first aspect of the present invention by a system according to independent claim 1, or is obtained according to a second aspect of the present invention by a display device according to independent claim 43.

Further, embodiments of the first and second aspect of the present invention are obtained according to dependent claims 2 to 42 and claim 44.

The display according to the first and second aspect of the present invention may comprise a rotary member mounted on a motor, where the rotary member may comprise a plurality of light emitting diodes and a processor capable of controlling these. When the rotary member rotates an image will be created in the area of the circumference of the rotary member when the light emitting diodes are controlled correctly. The rotary member may comprise light emitting diodes of more than one colour, making it possible to create a multicolour or full colour display. The display may be connected to a device capable of transferring data via a wireless protocol, this data being relayed to the display from a central server.

The image may comprise information such as a text, a sound, an image, an audio-recording, a series of images, or any combination thereof.

By introducing one or more sensors on the rotary member that are able to register an object, for instance a hand or a finger, in the near vicinity of the sensor a system can be created such that a touch-sensitive display may be created. The system comprises the rotary member with one or more sensors, the sensors being located so that each sensor is placed at a different length from the centre of rotation of the rotary member, preferably in such a way that the array of sensors is placed at regular intervals on the rotary member from the centre of rotation, to the edge, and a central processor able to receive input from the sensors. The central processor holds information enabling it to calculate the exact angle of a revolution that the rotating member is at any specific point in time. This enables the processor to establish exactly on which global point on the display an object, for instance a hand or a finger, is, as the angle and the length form the centre of rotation to the sensor is known. The processor unit may handle this information in such a way that when an object is in the vicinity of a sensor the processor unit performs an action, based on which global point on the display the object is in the vicinity of, the processor may for instance update the display.

The touch-sensitive display introduced by fitting the rotary member with one or more sensors may for instance be created using magnetic sensors that are able to register a change in the magnetic field, they may be created using acoustic sensors that are able to register a change in sound volume or modulation, or they may be created using light sensors that are able to register a change in light intensity, or they may be created using another technology.

A number of displays may be controlled from a central server using this technology, making it possible to update a number of displays simultaneously. By adding a wireless gateway to the server, which gateway is capable of communicating with a mobile device such as a mobile phone through GSM, GPRS, UMTS, I-mode or other technology, it may be possible for a user with a mobile device to communicate with one or more signs through the wireless gateway to the server, and finally the sign or signs.

Connecting the server to the Internet may enable communication with one or more displays over the Internet. By using information sent from users via a mobile device and stored and sorted on the server, which information comprises information about which display or group of displays the user wishes to communicate to, interact with or is watching, it is possible to create a database of demographic or other data relating to one display or a group of displays.

A display device comprising a rotary member comprising a plurality of light emitting diodes controlled by a central processor unit is currently only capable of displaying a picture consisting of one colour. This problem may be solved by introducing more than one light emitting diode in more than one colour such that the light emitting diodes of different colour are located on the rotary member such that when the rotary member rotates the pairs of light emitting diodes of different colour will be in the same global position at different angles of the revolution of the rotary member.

The central processor according to the first and second aspect of the present invention may be adapted to modulate the intensity of the light emitting diodes of different colours and may establish the exact location of each individual light emitting diode, thus creating the impression that one global point has a colour corresponding to the modulation of the light emitting diodes in question when they pass this global point. This approach makes it possible to create a full colour display by introducing three light emitting diodes of the colour red, green, and blue. This solves the problem of creating a display device that has the capability of displaying an image in more than one colour.

Any number of display devices may be adapted to communicate with the central server. It has previously been unknown for a display device using a rotary member to be able to communicate with a central server, but other advertising display devices are known to communicate with a central server, using a land based internet connection. By introducing communication from an display to a central server using wireless technology the problem of having an advertising display that requires a land based connection for set-up is solved. Furthermore, it is possible to easily move the display to another location. The system is created by having a display, particularly an advertising display connected to a communication unit communicating with a central server through a wireless gateway. This communication unit can be a communication device capable of communicating via GSM, GPRS, UMTS, bluetooth, I-mode or 802.11b. The display device is connected to the communication unit, such that the display is able to communicate with the communication unit. A server that is connected to a corresponding communication unit makes it possible for a central server to communicate with the display device using the communication units respectively placed in connection with the display device, and the server. The communication unit makes it possible to update the display device from the central server by transferring data through the communication unit to the display. By multicasting from the server to two or more displays, it is possible to update an array of displays at once.

The invention may relate to updating an advertising display with new advertising messages using the communication unit. It is possible to update an advertising display with new advertising messages, and it is possible for the display to show these at pre-designated times.

The system according to the first aspect of the present invention may further be adapted for communication with a wireless mobile device such as a mobile or cellular phone, a personal digital assistant, a computer, or any combination thereof. The communication may be established by having a mobile gateway connected to the central server, making it possible for a user to communicate from a mobile device to the server through said gateway. This enables a user to interact with one or more displays by interacting with the server through the gateway. If a user wishes to communicate to only one display, or a predefined group of displays the individual displays and/or group of displays may be assigned an ID tag that may be incorporated in the communication between the users mobile device and the central server. This communication may by example incorporate the user typing the ID tag for the desired display or group of displays in a communication session with the server. The central server may identify the display or displays in question by identifying it/them based on the ID tag, or information relating directly to an ID tag, such as the name of the place the display is placed. The server may utilises the information for updating the desired display.

Based on the users interaction the server may communicate with one or more displays. The mobile device may comprise a mobile phone or a personal digital assistant (PDA) that is connected to a mobile gateway. The mobile gateway may comprise WAP, GSM, GPRS, I-mode or UMTS. It is possible to create a system such that the gateway used for communicating from the mobile device to the server is a wireless gateway that comprises overtaxed text messages such as short messaging service (SMS) messages. This makes it possible to charge a user for communicating with the server through a mobile phone using SMS messages, and possibly updating one or more displays.

If the central server is connected to the Internet it is possible to control and update one or more displays from the Internet. This can be done through a program able to interact with the server, or it can be done through a browser. By adding a billing system it is possible to charge users for the service of updating one or more displays.

The central server according to the first aspect of the present invention may be adapted to store information submitted by users through the Internet, or through a wireless-gateway. The submitted information may be categorised in relation to one or more displays, based on the users submission of an ID tag along with other information submitted by said users. Based on this it is possible to derive information such as demographical data, age, gender, or other information submitted by users for the viewers of one display or a group of displays.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawing wherein:

FIG. 1a, shows a first embodiment of the display device according to the present invention;

FIG. 1b, shows a second embodiment of the display device according to the present invention;

FIG. 2, shows in detail the positioning of the light emitting device on the display device according to the first embodiment of the present invention;

FIG. 3, shows a system according to a first embodiment of the present invention;

FIG. 4, shows a system according to a second embodiment of the present invention;

FIG. 5, shows a system according to a third embodiment of the present invention;

FIG. 6, shows a system according to a fourth embodiment of the present invention;

FIG. 7, shows a system according to a fifth embodiment of the present invention.

### DETAILED DESCRIPTION OF PREFERRED EMBODIMENTS

In the following description of the various embodiments, reference is made to the accompanying figures which form a part hereof, and in which is shown by way of illustration various embodiments in which the invention may be practiced. It is to be understood that other embodiments may be utilized and structural and functional modifications may be made without departing from the scope of the present invention.

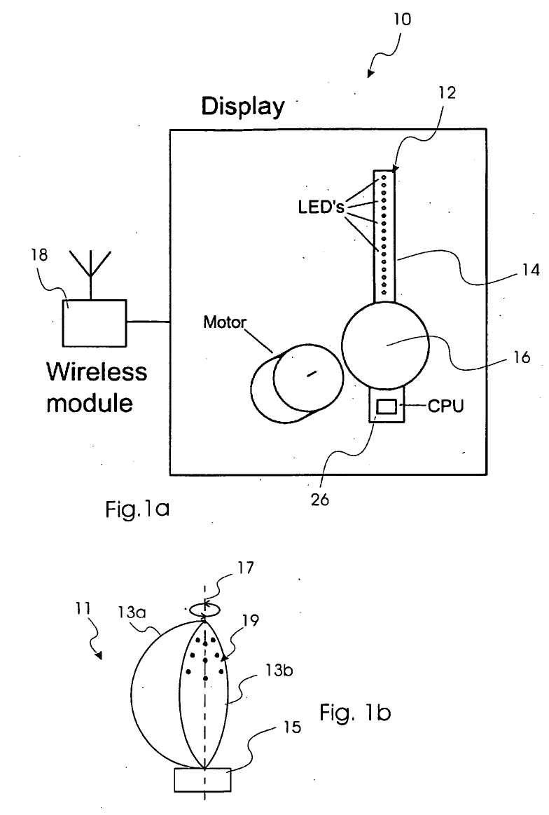

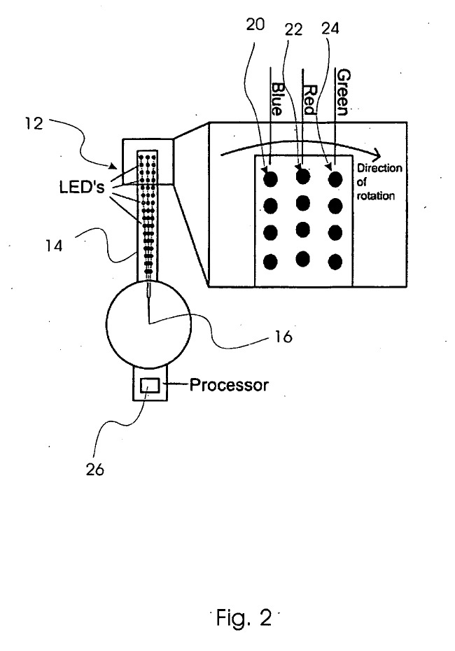

A display device 10 is created by placing an array of light emitting diodes 12 on a rotary member 14, see FIG. 1a. The light emitting diodes 12 are placed so that each light emitting diode is placed at a different length from the centre of rotation 16 of the rotary member 14, preferably in such a way that the array of light emitting diodes 12 is placed at regular intervals on the rotary member 14 from the centre of rotation 16, to the edge. When light emitting diodes of more than one colour are used, see FIG. 2, to create a colour display it is done by placing the light emitting diodes 20, 22, 24 of different colours on the rotary member 14 in such a way that they are at the same length from the centre of rotation 16, but placed at different angles in relation to the centre of rotation 16 on the rotary member 14. When the rotary member 14 is rotated light-emitting diodes 20, 22, 24 of different colour will pass by a single point in space. The central processing unit 26 is able to register where on the rotation the rotary member 14 is at a given point in time, and modulate the light emitting diodes 20, 22, 24 accordingly. When light emitting diodes 20, 22, 24 of different colour are modulated in the same point in space, as the light emitting diodes 20, 22, 24 placed on the rotary member pass this point it is possible to create the impression that the point in space is a given colour, based on the modulation of the two or more light emitting diodes. Preferably the rotary member 14 should have light-emitting diodes in the colours red green and blue, making it possible to create a full colour display by modulating a blue, red, and green light-emitting diodes 20, 22, 24 as they respectively pass the same point in space.

FIG. 1b shows a second embodiment of the display device 11 according to the present invention. The display 11 comprises a semicircular rotary member shown in FIG. 1b in a first position as reference numeral 13a facing the left side of the figure and in a second position as reference numeral 13b facing directly outward. The semicircular rotary member 13a, 13b is rotatably fixated to driving means 15 at one of its distal ends so that the semicircular rotary member 13a, 13b rotates about a rotation axis 17. On a surface of the semicircular rotary member 13a, 13b facing outward relative to the rotation axis 17 comprises a plurality of light emitting diodes 19, which may be configured so as to provide a coloured image when the semicircular rotary member 13a, 13b rotates. The plurality of light emitting diodes comprises red, green and blue diodes modulated by a central processing unit not shown in FIG. 1b.

The rotary member 13a, 13b, 14 is fixated at one of its a distal ends or fixated at its centre point to a rotation axle at the centre of rotation 16 with the plurality of light emitting diodes placed on each side of the centre point.

In a first embodiment of the present invention the rotary member 14 has a straight longitudinal cross-sectional profile. However, in a second embodiment of the display 11 the rotary member 13a, 13b has a semicircular longitudinal cross-sectional profile thereby, during rotating, generating a spherical viewing surface. A server, describe below may comprise a zooming function operable to zoom in on the information presented on the spherical viewing surface in accordance with a user touching or rather positioning an object in a sensitive area in the vicinity of the spherical viewing surface.

In an alternative embodiment of the present invention the rotary member may have a longitudinal cross-sectional profile may be open-sided triangular, open-sided square, semi-elliptical, or any combination thereof. The profile may in fact assume a wide variety of shapes, such as a bottle, a house, a glass, or a car, by having a longitudinal cross-sectional profile that during rotation will visualized the particular shape.

The semicircular rotary member 13a, 13b further comprise a plurality of sensors for detecting the presence of for example a user's finger. The plurality of sensors enable the display 11 to operate as a touch display having a spherical surface. The spherical surface is ideal for presenting information regarding the geography of the earth, countries and cities, or demographic maps, roadmaps or similar maps. Further, the spherical surface provides great advantages in presenting global weather patterns. An activation of the touch screen could for example result in a zooming function or turning function of the image.

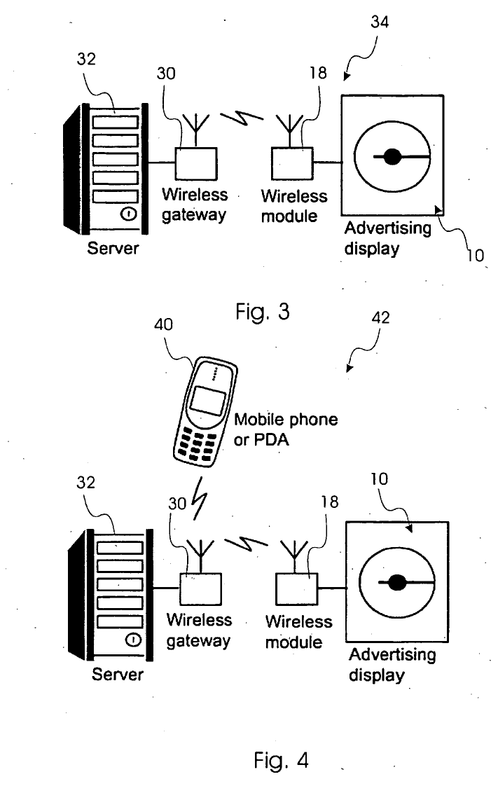

The information presented on the display 11 may be forwarded by a wired or wireless connection to a server as presented with reference to FIGS. 3 to 7. Additionally a user may present images on the display 11, which images are generated through a program to be run on a computer. The images may be forwarded to the display 11 through for example the Internet.

The central processing unit 26 according to an alternative embodiment of the present invention executes a program code transforming the image to be presented on the display 10 from Cartesian to polar coordinates. This program code, which may be run on the server described below or a computer hooking up to the display 10 through the server, achieves that the image shown on the display 10 is not “bent” around the centre but appears as a normal image with normal coordinates.

The rotating member according to a further alternative embodiment of the present invention is formed so that the light emitting diodes 20, 22, 24 are placed on the rotating member 14, which rotating member 14 extends on either side from the centre of rotation 16. The light emitting diodes 20, 22, 24 on each side relative to the centre of rotation 16 is offset by half a pixel. This configuration allows a slower rotation of the rotating member 14 while achieving the effect of a non flickering display 10 due to the interlaced effect.

The rotary member 14, or another display device may be connected to a communication unit 18, said unit 18 being able to send and receive digital information from a central server. The rotary member 14, or another display device, particularly an advertising display, may be connected to the communication unit 18 or integrated with it in such a way that it is possible to transfer data from the communication unit 18 to the rotary member 14, and may be possible to transfer data from the rotary member 14 to the communication unit 18. The communication unit 18 can communicate via wireless to a wireless gateway 30, said gateway 30 being able to communicate with a server 32.

The system 34 according to a first embodiment of the present invention, shown in FIG. 3, makes it possible to create a two way communication between the display device 10 and the server 32. It is possible using this system 34 to update the display device 10, which may be a rotary member 14 or an advertising display, by sending information through the wireless gateway 30 to the display device 10 through the wireless module 18. The wireless module 18 and the wireless gateway 30 can communicate using WAP, using GSM, using GPRS, using UMTS, using bluetooth, using 802.11b, using I-mode, or using another suitable technology.

The system 42 according to the first through fifth embodiment of the present invention furthermore comprise a second wireless gateway, which may be the same as the wireless gateway 30 used to communicate with the display device 10, or it may be a different wireless gateway using the same or a different wireless protocol. The second wireless gateway, shown in FIG. 4 as reference numeral 30, can be used for communicating with mobile devices 40. The mobile device 40 may be, but is not limited to: mobile phones or personal digital assistants with a connectivity that allows them to communicate with said second wireless gateway 30.

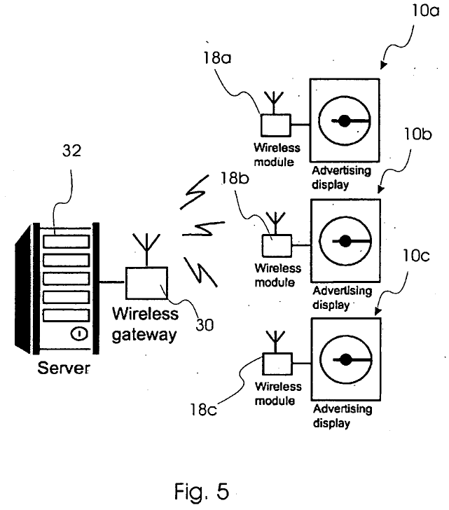

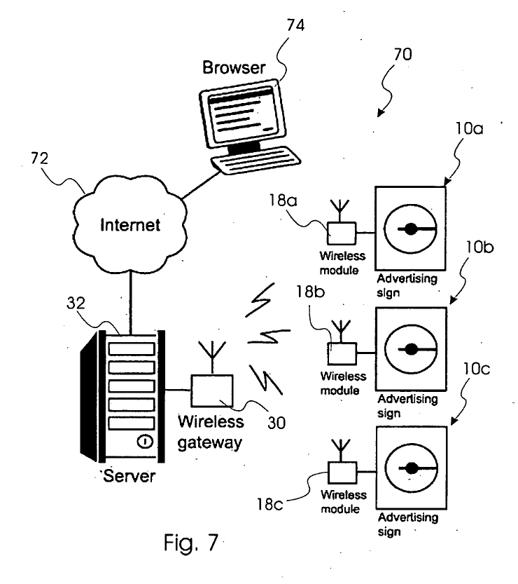

The system according to the third, fourth and fifth embodiment of the present invention comprises several servers that are connected, for instance through the Internet, shown in FIG. 7 as reference numeral 72, or through a virtual private network. When communicating from the server 32 to an array of displays 10a, 10b, 10c this may be done by point to multipoint communication, such that more than one display can receive the information that is sent through the wireless gateway 30 to the wireless module 18a, 18b, 18c and to two or more displays 10a, 10b, 10c, see FIGS. 5, 6, and 7.

Communication between the plurality of serves connected together via the Internet follows the RSS standard, an XML based protocol generally employed by the media industry. In an alternative embodiment the communication between the plurality of servers connected together via the Internet follows a markup language such as HTML.

Connecting servers designated content providers forward images, e.g. news, to be displayed on the display 10 to the server 32. The server 32 updates the content of the display 10 according to a profile set for the particular display 10. The content may be segmented according to placement of the display 10, that is, parameters such as potential age, gender and sex of a viewers, determine which content the display 10 shows.

The system 42 according to the second embodiment of the present invention enables a user operating the mobile device 40 to communicate with the server 32 through said second wireless gateway 30. The server 32, when communicating with the mobile device 40, comprises a program that allows one or more display devices 10 to be updated. This update comprises a text message sent by the user of the mobile device using for instance SMS, this message being relayed in full or parsed to a display device. The update further comprises a predefined action such as for instance showing a picture on one or more displays. When a user communicates with the server 32 this communication may be to a particular wireless gateway 30 that comprises the ability to charge the user an amount of money for the communication, for instance using an overtaxed SMS service. Said wireless gateway 30 can be connected directly to the server 32, or it may relay information the server 32, either directly or through an appropriate means.

A user operating a mobile device 40 may also connect directly to the display 10, by means of the mobile device 40 communicating with the wireless module 18 connected to the display 10, and the wireless module 18 relaying information to the display 10. The user may utilise a mobile device 40 for capturing an image by on-device camera or downloaded via the wireless telecommunication network. The image may be forwarded to the display 10 using multimedia messaging server MMS, e-mail or similar messaging technologies known by a person skilled in the art. Subsequently, the server 32 forwards the image to the display 10.

The server 32 identifies the mobile device, when the mobile device 42 interacts with the display 10 through the server 32, and generates a user profile for the mobile device 42.

FIG. 5 shows a plurality of displays 10a, 10b, 10c each connecting to an associated wireless module 18a, 18b, 18c. Each individual display 10a, 10b, 10c may comprise a unique ID tag, making it possible to identify each display 10a, 10b, 10c separately. This makes it possible to communicate to only one, or a specific group of displays 10a, 10b, 10c. If a user wishes to communicate with one particular display 10a, 10b, 10c he may do so by communicating the ID tag, or information that the server 32 is able to identify as relating to said ID tag. If a user is watching or has been watching a particular display 10a, 10b, 10c, the display 10a, 10b, 10c may show the ID tag or information that the server 32 is able to identify as relating to said ID tag, and the user may communicate to only one or a particular group of displays 10a, 10, 10c based on the ID tag. This communication based on ID tags or information that the server is able to identify as relating to said ID tags may be stored, for instance on the server 32. The server 32, or another server, may hold a database with information about said communication, along with other parameters for a particular display. 10a, 10b, 10c. This information makes it possible to calculate and show information regarding demographics, usage and other data about an individual display. If the user communicates information such as age, gender, or other information this information, along with the ID tag may also be stored, and the database will be able to show this information in whole, or in a calculated form, such as for instance an average, making it possible for the database to hold information about for instance average age of viewers of a particular display 10a, 10b, 10c. Instead of using an ID tag to identify a particular display 10a, 10b, 10c it may also be identified by locating the mobile device 40 using for instance triangulation, and assuming that the display 10a, 10b, 10c the user wishes to communicate to is the one nearest to this location.

The server 32 generates a user profile on the basis of the user's communication with one of the displays 10a, 10b, 10c together with the ID tag identified by the server 32.

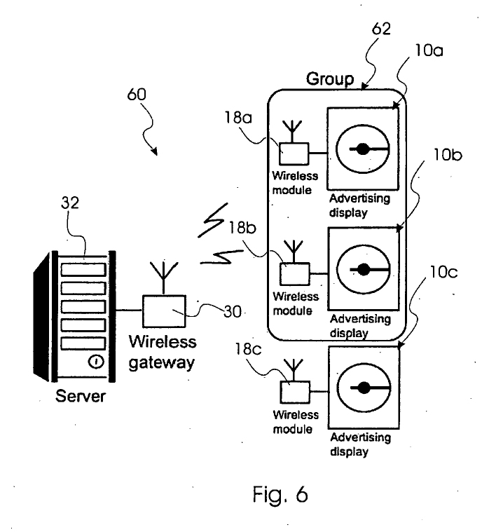

The server 32 connecting to the displays 10a, 10b, 10c utilizes The system 60 according to the fourth embodiment of the present invention comprises a program that may be located on the server 32, which program is able to group two or more displays 62 based on parameters such as location, average age, frequency of a user communicating with a display or other information. A defined group 62 may comprise an ID tag, making it possible to use point to multipoint communication to send information to the displays 10a, 10b, 10c in that group 62. See FIG. 6.

The server 32 according to an alternative embodiment of the present invention comprises a program transforming the image to be presented on the display 10 from normal to polar coordinates. This program achieves that the image shown on the display 10 is not “bent” around the centre by appears as a normal image with normal coordinates. Additionally, the server 32 is capable of transforming images received or stored in a standard format such as JPEG into a display format, which readable by the displays 10a, 10b, 10c. The display format may be a vector-based format so as to minimize the data transmission requirements. The vector-based format is smaller and more compressible than comparable JPEG and GIF.

In the system 70 according to the fifth embodiment of the present invention, shown in FIG. 7, the server 32 is connected to the Internet 72, either directly or through another server or device, making it possible to communicate from the server 32 to the Internet 72. This makes it possible for a user using a computer 74 or a program connected to the Internet to communicate with one or more displays 10a, 10b, 10c through the server 32. This makes it possible for the user to either send messages directly to one or more displays 10a, 10b, 10c, particularly a group of displays, such as shown in FIG. 6 as reference numeral 62, or to communicate with the server 32, the server 32 scheduling information to be sent to one or more displays 10a, 10b, 10c at a later time. A user may pay for this service through a billing system. This may be using a credit card to pay for said communication.

The price of messages on a display 10, 11 may be calculated by assessing number of viewers per display 10a, 10b, 10c. The assessment may be based on the number of interactions (touch or mobile device activations) are recorded. The interactions may be assessed by applying a camera or an audio-detector, such as a microphone, associated with the displays 10a, 10b, 10c. Further, the interactions may be assessed by having a counter in the proximity of the displays 10a, 10b, 10c, which counter reports the number of views to the server 32.

The server 32 comprises a web-based search engine enabling a computer 74 connecting to the server 32 through the communication network 72 searches for a specific display 10a, 10b, 10c according to searching parameters, such as geographic or demographic data. Further, the server 32 enables the computer 74 to request information to be forwarded to a selected display 10a, 10b, 10c.

Additionally, the server 32 calculates a price for providing the information on the display 10a, 10b, 10c in accordance with an assessment of number of viewers at the display 10a, 10b, 10c. Hence the system 70 further comprises a counter for counting number of viewers at each display 10a, 10b, 10c, which counter provides a count value based on a sensor signal from a sensor such as a camera, microphone, infrared sensor, or pressure sensor, and the server 32 performs the assessment on the basis of this count value.

The server 70 stores the sensor signal in a searchable database and performs a comparison of the sensor signal with content of the searchable database so as to continuously keep track of which type of viewers are present at particular displays 10a, 10b, 10c. The information regarding the viewers is particularly advantageous when the display functions as a display for adds or commercials, since the server 70 may act according to the various viewers present at the display 10a, 10b, 10c and thus personalize the adds or commercials for that particular viewer group.

Similarly, the system 70 may comprise a connection to peripheral equipment such as a cash register thereby presenting adds in accordance with information entered in the cash register. THe connection may be any wired or wireless connection known to a person skilled in the art.

1. A system for presenting and controlling information on a display device and comprising a server, a wireless gateway and said display device having a wireless module communicating with the server through the wireless gateway, and said server is adapted to update information presented on the display device through the wireless gateway.

2. A system according to claim 1, wherein the display device comprises a rotary member with a plurality of light emitting diodes of at least two colours arranged such that pairs of light emitting diodes of different colours will pass through the same global point on the display once every revolution of the rotary member, and a processing unit able to control the light emitting diodes, such that the processing unit can create the impression of a global point of a chosen colour created by modulating the intensity of the light emitting diodes of different colour when they pas through said global point.

3. A system according to claim 1, furthermore comprising a mobile device able to communicate with the server through the wireless gateway.

4. A system according to claim 3, wherein the mobile device is adapted to update the display device with said information by communicating with the server through the wireless gateway.

5. A system according to claim 1, wherein the wireless gateway operated in accordance with GMS, GPRS, UMTS, 802.11b, bluetooth, I-mode, or any combination thereof.

6. A system according to claim 1, further comprising one or more display devices, and wherein the server is adapted to multicast said information to the one or more display devices substantially simultaneously using the wireless gateway.

7. A system according to claim 1, wherein said information contains a text, a sound, an image, or audio-recording, a series of images, or any combination thereof.

8. A system according to claim 1, wherein the system is adapted to group the one or more display devices according to the parameters set for each of the one or more display devices so as to display specific information for each group of the one or more display devices.

9. A system according to claim 1, wherein the server and the display device is connected to a communications network such as a wired or wireless dedicated line, local area network, metropolitan area network, wide area network, the Internet, or any combination thereof, so as to enable communication between the server and the display device.

10. A system according to claim 9 further comprising a computer connected to the communications network and comprising a program for controlling the display device through the server.

11. A system according to claim 10, wherein said computer program comprises a transforming procedure adapted to transform said information from Cartesian to polar coordinates.

12. A system according to claim 10, wherein said server is adapted to store and execute said computer program.

13. A system according to claim 1, wherein said information is accessible by said display device utilizing a vector-based accessing format.

14. A system according to claim 1, wherein the system is adapted to request a user payment for displaying information on the display device.

15. A system according to claim 14, wherein the payment is performed with a credit card.

16. A system according to claim 1, wherein the system is adapted to charge a mobile device for communicating with the server.

17. A system according to claim 16, wherein the charge is carried out using overtaxed text message.

18. A system according to claim 1, wherein a mobile device is adapted to send a message to the server, which message comprises an unique ID tag for the display device.

19. A system according to claim 8, wherein the grouping is based on demographic information, such as location, average age, gender.

20. A system according to claim 19, wherein the demographic information is collected from the mobile device communicating with the server.

21. A system according to claim 3, wherein the mobile device provides configuration information to the server sorting the configuration information according to the ID tag of each display device.

22. A system according to claim 3, wherein said server is adapted to identify said mobile device, when said mobile device interacts with said display device through said server, and is adapted to generate a user profile for said mobile device.

23. A system according to claim 2, wherein said display device further comprises a recording device located on said rotary member for recording user interaction in a touch sensitive area.

24. A system according to claim 23, wherein said recording device comprises one or more sensors, the sensors being location so that each sensor is placed at a different length from a centre of rotation of the rotary member.

25. A system according to claim 24, wherein said one or more sensors are placed at regular intervals on the rotary member from the centre of rotation, to the edge.

26. A system according to claim 24, wherein said recording device further comprises a central processor adapted to receive input from said one or more sensors.

27. A system according to claim 26, wherein said central processor is adapted to hold information enabling said central processor to calculate the exact angle of a revolution of an associated rotating member in any specific point in time.

28. A system according to claim 26, wherein said central processor is adapted to perform an action when an object is in the vicinity of said one or more sensors, said action being based on which global point on the display device the object is in the vicinity of.

29. A system according to claim 24, wherein said one or more sensors are magnetic sensors registering changed in the magnetic field.

30. A system according to claim 24, wherein said one or more sensors are acoustic sensors registering changes in sound volume or modulation.

31. A system according to claim 24, wherein said one or more sensors are light sensors registering changes in light intensity.

32. A system according to claim 2, wherein said rotary member is fixated at one of it's distal ends to a rotation axle.

33. A system according to claim 2, wherein said rotary member is fixated at its centre point to a rotation axle having said plurality of light emitting diodes placed on each side of said centre point.

34. A system according to claim 2, wherein said rotary member comprises a longitudinal cross-sectional profile formed to illustrate when rotating a specific shape such as a bottle, a house, a glass, or a car.

35. A system according to claim 2, wherein said rotary member comprises a semicircular longitudinal cross-sectional profile thereby when rotating said rotary member generating a spherical viewing surface.

36. A system according to claim 35, wherein said server comprises a zooming function operable to zoom in on said information presented on said rotary member generating the spherical viewing surface.

37. A system according to claim 2, wherein said rotary member comprises a longitudinal cross-sectional profile being an open-sided triangular, an open-sided square, a semi-elliptical, or any combination thereof.

38. A system according to claim 1, wherein said server comprises a web-based search engine enabling computers connecting to said server through said communication network searches for a specific display device according to searching parameters, such as geographic or demographic data, and enabling said computers to request information to be forwarded to a selected display device.

39. A system according to claim 1, wherein said server is adapted to calculate a price for providing said information on said display device in accordance with an assessment of number of viewers at said display device.

40. A system according to claim 39, further comprising a counter for counting a number of viewers at said display device, which counter is operable to provide a count value on reception of a sensor signal from a sensor such as a camera, microphone, infrared sensor, or pressure sensor, and said server performing said assessment on the basis of said count value.

41. A system according to claim 40, wherein said server is adapted to store said sensor signal in a searchable database and to perform a comparison of said sensor signal with content of said searchable database.

42. A system according to claim 1, further comprises a connection for linking to a peripheral equipment such as a cash register.

43. A display device comprising a rotary member with a plurality of light emitting diodes of at least two colours arranged such that pairs of light emitting diodes of different colours will pass through the same global point on the display once every revolution of the rotary member, and a processing unit able to control the light emitting diodes, such that the processing unit can create the impression of a global point of a chosen colour created by modulating the intensity of the light emitting diodes of different colour when they pass through said global point.

44. (canceled)
